(19) United States
(12) Patent Application Publication
(10) Pub. No.: US 2002/0006302 A1
(43) Pub. Date: Jan. 17, 2002

(54) CUTTING APPARATUS AND PRINTERS PROVIDED WITH CUTTING APPARATUS

(76) Inventors: KOJI YAMADA, NAGANO (JP); TORU TAKAMI, NAGANO (JP)

Correspondence Address: NIXON & VANDERHYE, P.C., 1100 NORTH GLEBE RD, 8TH FLOOR, ARLINGTON, VA, 22201-4714, US

(21) Appl. No.: 09/409,028

(22) Filed: Sep. 29, 1999

(30) Foreign Application Priority Data
Sep. 29, 1998 (JP) HEI. 10-276212

(51) Int. Cl. B41J 11/48; B41J 17/08

(52) U.S. Cl. 400/593

(57) ABSTRACT

ABSTRACT OF DISCLOSURE A printer with the cutting apparatus with a shield that protects the cutting part of a cutter blade in the apparatus, and a printer with the cutting apparatus is disclosed. A fixed blade is supported so that the fixed blade can be moved by pressure by a compression coil spring upon a fixed blade supporting frame attached to a body frame so that the fixed blade supporting frame can be opened or closed. A blade cover for protecting the cutting part of the fixed blade is fixed to the fixed blade supporting frame. When each fitting between fitting parts of the fixed blade and touching parts of a cutter frame is released in a state in which the fixed blade supporting frame is open, a part or the whole of the cutting part of the fixed blade is shielded by the shielding part of the blade cover.

### BACKGROUND OF INVENTION

1. Field of invention

The present invention relates to a cutting apparatus for cutting recording paper and a printer provided with the cutting apparatus, and in particular relates to a cutting apparatus provided with a mechanism for protecting the blade of the cutting apparatus and the printer provided with the cutting apparatus.

2. Related art

Generally, a printer applied to an electronic cash register used in point of sales (POS) is provided with a cutting apparatus for cutting recording paper to issue as a receipt after rolled recording paper is printed by a print head according to methods such as a thermosensible method.

The type of cutting apparatus described above is called “scissors-type” cutting apparatus which is one type of the cutting apparatus comprises a movable blade and a fixed blade respectively arranged opposite with a transport path of recording paper between the above blades. The movable blade is moved in a direction perpendicular to recording paper and the recording paper is cut from one end to the other end. This type of cutting apparatus is disclosed in Japanese published unexamined utility model No. Hei2-10953.

A cutting apparatus with a movable blade that is arranged on the side of the body of a printer, the fixed blade is arranged on a cover supported by the body of the printer so that the cover can be opened or closed. The recording paper is cut by sliding the movable blade on the fixed blade in a known state in which the cover is closed.

Another type of cutting apparatus is disclosed in Japanese published unexamined patent application No. Sho60-16400. In this reference the cutting apparatus is provided on a cover. The cutter includes a shielding member for shielding a cutter blade along with the movement of the cover. The shielding member shields the cutter blade when the cover is opened, and when the cover is closed, the shielding member is exposed. When the cover is opened and closed to replace rolled paper, damage to the exposed blade is prevented.

However, in a conventional type cutting apparatus, a mechanism such as a cam is required to move between a position in which the cutting part of the cutter blade is shielded by the shielding member and a position in which the cutting part is exposed as the cover is opened or closed. This type of configuration can be complicated. In addition, as the shielding member is gradually moved from the exposed position to the shielded position as the cover is opened, unless the cover is completely open, the cutter blade cannot be shielded and protected.

### SUMMARY OF INVENTION

The present invention provides a cutting apparatus wherein a cutter blade can be securely protected with a simple configuration. In addition, a printer provided with the cutting apparatus is provided.

In one aspect, a cutting apparatus is provided with first and second cutter blades arranged opposite with the transport path of recording paper between them, first supporting structure for supporting the first cutter blade and second supporting structure, which can be moved with respect to the first supporting structure, for supporting the second cutter blade, and is characterized in that the second cutter blade is supported so that it can be moved to a first position in which recording paper can be cut in cooperation with the first cutter blade and a second position in which recording paper cannot be cut without incorporating with the first cutter blade depending upon the position of the second supporting structure and the second supporting structure is provided with a first projection protruded on the side of the second cutter blade from the surface contact with the second cutter blade in the second position and located on the side of the transport path of the second cutter blade.

When the second supporting structure is arranged in a position in which the first and second cutter blades are not in cooperation, the second cutter blade is moved and a part or the whole of its cutting part is shielded by the first projection. The cutting part of the second cutter blade can be protected without causing chipping and others in the cutting part of the second cutter blade.

In an implementation, when the second supporting structure is provided with an elastic body and the second cutter blade is located in the second position, it is desirable that the second cutter blade is pressed against the contact surface of the second supporting structure by the elastic force of the elastic body and a part or the whole of the second cutter blade is shielded by the first projection. It is also desirable that the first supporting structure is provided with a touching part for coming in contact with the second cutter blade and moving the second cutter blade to the first position against the elastic force of the elastic body.

As the cutting part of the second cutter blade is automatically shielded by the first projection in case the second supporting structure is moved and the first and second cutter blades are not in cooperation, the cutting part of the cutter blade can be securely protected.

As the cutting part of the second cutter blade is automatically exposed from the first projection in case the second supporting structure is moved and the first and second cutter blades are in cooperation, special operation for putting the cutter blade in a state in which it can cut recording paper is not required and a cutter easy to handle can be acquired.

The cutter blade can be shielded or exposed with simple configuration without requiring a complicated mechanism such as a cam mechanism by utilizing the elastic force of the elastic body.

In an implementation, the first projection is fixed to the second supporting structure.

As the projection is not moved even if the second supporting structure is arranged in a position in which the first and second cutter blades are not in cooperation and external force is applied to the first projection, the second cutter blade can be more securely protected.

In an implementation, a guide part for guiding the carriage of recording paper is provided and the guide part is integrated with the shielding part.

The leading end of recording paper can be securely guided to the cutter blade along the guide part. As the guide part for guiding recording paper is moved together with the second supporting structure and the transport path of recording paper is free in case the second supporting structure is moved and the first and second cutter blades are put in a state in which they are not in cooperation, work such as replacing rolled paper can be easily performed.

In an implementation, the second supporting structure is provided with a second projection on the side opposite to the surface contact with the second cutter blade of the second supporting structure with the second cutter blade between.

The second cutter blade can be more securely protected in cooperation with the first projection.

In an implementation, the first cutter blade is a movable blade and the second cutter blade is a fixed blade. A so-called scissors-type cutting apparatus wherein the first cutter blade is contact with the second cutter blade at a point to subject the scissors-like sliding action.

Since a mechanism for driving the movable blade is not required to be provided to the turned second supporting structure, the configuration is simplified.

In another aspect, a printer provided with a cutting apparatus which can securely protect the cutting part of the fixed blade is also acquired. The printer is provided with a main frame including a print unit for printing on recording paper and a cover frame supported by the main frame so that the cover frame can be opened or closed and is characterized in that the main frame includes the first supporting structure, the cover frame includes the second supporting structure and the cover frame is pivotally supported so that the cover frame can be turned between a closed position equivalent to the first position and an open position equivalent to the second position.

Other features and advantages will be readily apparent from the following description, the accompanying drawings, and the claims.

### BRIEF DESCRIPTION OF THE DRAWINGS

FIG. 1 is a front view showing the main part of the internal configuration of a printer in which a cover frame is open.

FIG. 2 is a front view of the printer of FIG. 1 in which the cover frame is closed.

FIG. 3 is a cut away view of the main part of the internal configuration of the printer of FIG. 1.

FIG. 4 is a sectional view viewed along a line X-X in FIG. 3.

FIG. 5 is a sectional view viewed along a line Y-Y in FIG. 3.

FIG. 6 is a sectional view of an alternate embodiment.

### DETAILED DESCRIPTION OF PREFERRED EMBODIMENTS

Referring to the drawings, embodiment of a printer according to the present invention will be described in detail below.

A printer described in this embodiment is provided with a scissors-type cutting apparatus includes a fixed blade and a movable blade as described later.

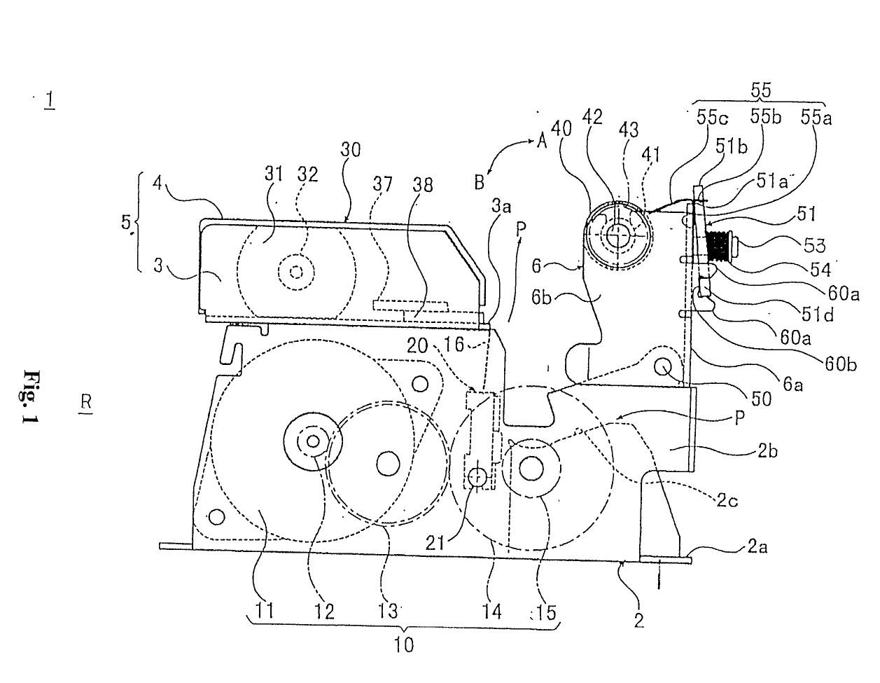

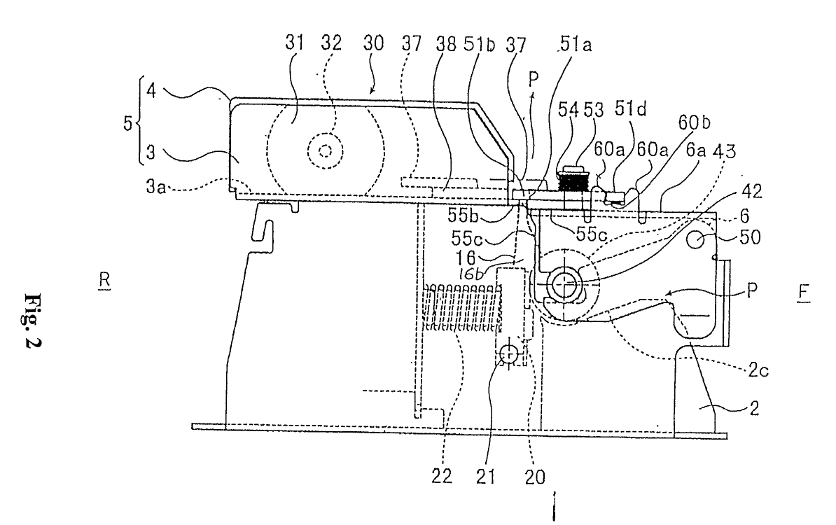

FIGS. 1 and 2 are front view showing the main part of the internal configuration of the printer according to the present invention and show a state in which a cover frame is open and a state in which it is closed.

As shown in FIG. 1 or 2, a printer 1 is provided with a body frame 2 and a fixed blade supporting frame 6 (second supporting structure, hereinafter also called a cover frame) which is pivotally supported on the body frame 2.

The body frame 2 comprising the bottom 2a and the side 2b formed at both ends of the bottom 2a. The fixed blade supporting frame 6 located in the upper part on the front side (the side of F in the drawings) of both sides 2b of the body frame 2 for supporting a fixed blade 51 (a second cutter blade) is pivotally supported by a spindle 50 in a direction shown by an arrow A and B so that the fixed blade supporting frame 6 can be opened or closed with respect to the main body 2.

The fixed blade supporting frame 6 comprises a flat supporting structure 6a and a side 6b formed at both ends of the supporting structure 6a and both sides 6b are supported by the body frame 2 in a state in which both sides are respectively overlapped with both sides 2b of the body frame 2. In an embodiment, the body frame 2 and the fixed blade supporting frame 6 are formed by folding sheet metal.

A cutter unit 30 in which a movable blade 37 (a first cutter blade) is housed is mounted on the upper part on the rear side (the side of R in the drawings) of both sides 2b of the body frame 2. The cutter unit 30 is provided with a cutter case 5 (first supporting structure) comprising a cutter frame 3 and a cutter cover 4. The movable blade 37 and a cutter motor 31 for driving the movable blade 37 are arranged in the cutter case 5.

A thermal head 20 is provided inside both sides 2b of the body frame 2 with a spindle 21 in the center so that the thermal head can be turned. The thermal head 20 is connected to a circuit board (not shown) via a cable and as shown in FIG. 2, is pressed on a platen roller 40 (as described below) by a head pressing spring 22.

The platen roller 40 is attached to the fixed blade supporting frame 6 and is arranged so that the platen roller is opposite to the thermal head 20 in a state in which the fixed blade supporting frame 6 is closed. The platen roller 40 is supported so that it can be turned by making a bearing 41 attached to the fixed blade supporting frame 6 support a platen shaft 42. Recording paper passes between the thermal head 20 and the platen roller 40 and is printed by the thermal head 20.

A driver unit 10 for rotating the platen roller 40 is provided inside both sides 2b of the body frame 2 as shown in FIG. 1. The driver unit 10 comprising a driving motor 11 provided on the rear side (the side of R) of the body frame 2 and a gear train for transmitting the torque of the driving motor 11 and the torque is transmitted from a motor gear 12 to an intermediate gear 14 via a reduction gear 13. The platen roller 40 is rotated by making a platen gear 43 fixed to one end of the platen shaft 42 engaged with a gear 15 coaxial and integrated with the intermediate gear 14 in a state in which the fixed blade supporting frame 6 is closed. Recording paper is carried along a transport path P (described below) as the platen roller 40 is rotated.

A printing guide 2c for guiding recording paper pulled out from a roll paper (not shown) toward between the thermal head 20 and the platen roller 40 is provided on the front side (the side of F) of the body frame 2. A cutter guide 16 is attached to the back of the bottom 3a of the cutter frame 3. The cutter guide 16 comprising a mounting part 16a overlapped with the back of the bottom 3a of the cutter frame 3 and a guide part 16b bent in a direction approximately perpendicular to the mounting part 16a. In an embodiment, the cutter guide 16 is formed by bending a stainless steel sheet. The cutter guide 16 is arranged so that its guide part 16b is directed to the thermal head 20. Recording paper is guided from the front side (the side of F in the drawings) of the body frame 2 to a printing guide part 2c. The recording paper then passes between the thermal head 20 and the platen roller 40, between the guide part 16b of the cutter guide 16 and a blade cover 55 (as described below), and between the fixed blade 51 and the movable blade 37. Finally, the recording paper is carried outside the printer 1 (the transport path P).

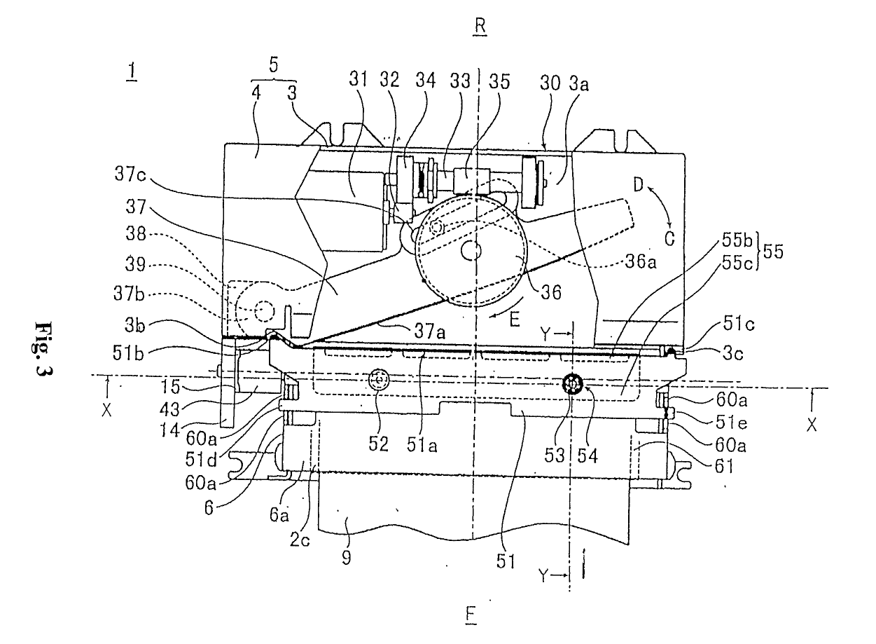

Referring to FIG. 3, the cutter unit 30 is described. FIG. 3 is a plan view of a part of which cut out showing the main part of the internal configuration of the printer of the present invention. The movable blade 37 comprises a substantially rectangular plate member, a cutting part 37a formed at one edge in the longitudinal direction and a long hole 37c formed in the approximately center at the other end. In an embodiment, the movable blade is metallic. The movable blade 37 is supported at the end 37b on the side from which cutting is started. The movable blade can be turned with a spindle 39 provided on the front side (side F in FIG. 3) of the bottom 3a of the cutter frame 3 in the center in a direction shown by an arrow C or D.

A spacer 38 is provided between the end 37b of the movable blade 37 and the bottom 3a of the cutter frame 3 to secure a predetermined quantity of clearance between the movable blade 37 and the bottom 3a of the cutter frame 3 (see FIG. 1 or 2).

The cutter motor 31 is arranged in the rear part of the cutter frame 3 and on the side of spindle 39 not to prevent the movable blade 37 from being turned. The torque of the cutter motor 31 is transmitted to a gear 32 fixed to the rotating shaft of the cutter motor 31, a gear 34 engaged with the gear 32, a driving shaft 33 rotated together with the gear 34 and a worm wheel 36 engaged with a worm 35 via the worm 35 fixed to the driving shaft 33. The worm wheel 36 is rotated in a predetermined direction (for example, a direction shown by an arrow E in FIG. 3).

A crank pin 36a protrudes from the back (the side of the bottom 3a of the cutter frame 3) of the worm wheel 36 so that the crank pin 36a fits into the long hole 37c of the movable blade 37. Thus, the movable blade 37 is turned in the direction shown by the arrow C or D with the spindle 39 in the center of a turn. Recording paper 9 is cut by turning the movable blade 37 in the direction shown by the arrow C and the movable blade 37 can be positioned in a standby position by turning the movable blade 37 in the direction shown by the arrow D.

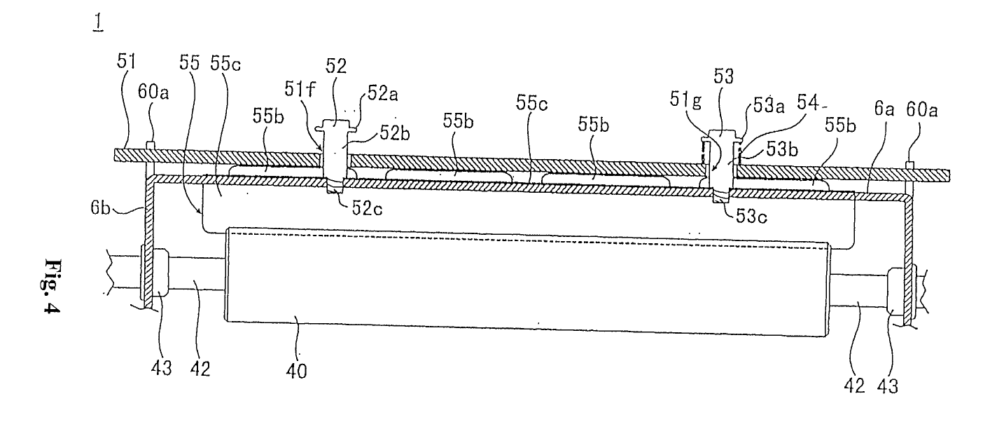

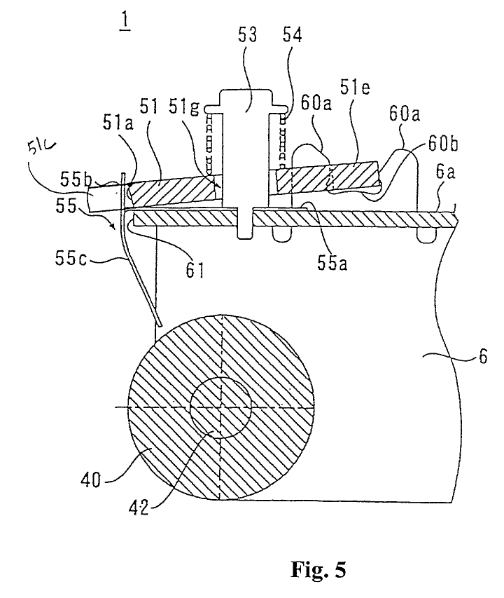

Referring to FIGS. 3, 4 and 5, the fixed blade supporting frame 6 is described. FIG. 4 is a sectional view viewed along a line X-X in FIG. 3 and FIG. 5 is a sectional view viewed along a line Y-Y in FIG. 3. As shown in the drawings, the fixed blade 51 for cutting recording paper 9 in cooperation with the above movable blade 37 is arranged over the supporting structure 6a of the fixed blade supporting frame 6. The fixed blade 51 comprises a metallic approximately rectangular plate member and its cutting part 51a is formed at one edge in the longitudinal direction. Two fitting projections 51b and 51c are formed at both ends of the cutting part 51a so that they are protruded in a direction approximately perpendicular to the longitudinal direction of the fixed blade 51. The cutting part 51a of the fixed blade 51 is arranged along the rear edge of the supporting structure 6a of the fixed blade supporting frame 6. The fitting projections 51b and 51c protrude from the rear edge of the supporting structure 6a toward the cutter frame 3. Supporting projections 51d and 51e are formed at both ends of the other end in the longitudinal direction of the fixed blade 51 so that the supporting projections protrude in the longitudinal direction of the fixed blade 51. Holes 51f and 51g for piercing supporting shafts 52 and 53 (as described below) are provided at a predetermined interval in the fixed blade 51.

A positioning support 60 approximately in the shape of U for positioning and supporting the fixed blade 51 protrudes from the edge on both sides of the supporting structure 6a of the fixed blade supporting frame 6. The positioning support 60 comprises a pair of positioning parts 60a provided at a predetermined interval and a supporting bottom 60b formed between the positioning parts 60a. The supporting bottom 60b is provided in a position apart by predetermined distance from the surface of the supporting structure 6a as shown in FIG. 5. The supporting projections 51d and 51e of the fixed blade 51 are fitted to the positioning support 60. An interval between the positioning parts 60a is formed so that it is slightly wider than the width of each supporting projection 51d or 51e. Thus, the fixed blade 51 is supported with slight clearance by the positioning support 60.

The two supporting shafts 52 and 53 supporting the fixed blade 51 are arranged at a predetermined interval in the supporting structure 6a of the fixed blade supporting frame 6 in such a manner that the fixed blade 51 moves with respect to the fixed blade supporting frame 6. These supporting shafts 52 and 53 respectively pierce the holes 51f and 51g provided to the fixed blade 51 and are attached to the supporting structure 6a of the fixed blade supporting frame 6.

As shown in FIG. 4, a headed screw is used for the supporting shafts 52 and 53. The supporting shaft 52 comprises a head 52a, a shank 52b having a smaller diameter than the diameter of the head 52a and a threaded portion 52c having a smaller diameter than the diameter of the shank 52b. The supporting shaft 53 comprises a head 53a, a shank 53b having a smaller diameter than the diameter of the head 53a and a threaded portion 53c having a smaller diameter than the diameter of the shank 53b as the supporting shaft 52.

The holes 51f and 51g provided to the fixed blade 51 are formed so that each inner diameter is larger than the outer diameter of the shank 52b or 53b of each supporting shaft 52 or 53. The outer diameter of the head 52a or 53a of each supporting shaft 52 or 53 is formed so that it is larger than the inner diameter of each hole 51f or 51g.

An elastic structure 54 is inserted between the head 53a of one supporting shaft 53 and the fixed blade 51 and the fixed blade 51 is pressed on the supporting structure 6a of the fixed blade supporting frame 6 by the elastic force of the elastic structure 54. In an embodiment, the elastic structure 54 is a compression coil spring.

In such a configuration, the fixed blade 51 could be moved around an axis defined by the supporting projections 51d and 51e on the supporting structure 6a against the elastic force of the elastic structure 54.

As shown in FIG. 5, a blade cover 55 is attached to the fixed blade supporting frame 6. The blade cover 55 comprises a flat mounting part 55a, plural rectangular shielding parts 55b (first projections) approximately perpendicular to the mounting part 55a, and a guide part 55c extended on the same plane as the shielding part 55b and bent on the side of the mounting part 55a from its halfway part to the end. In an embodiment, the blade cover 55 is formed by slitting and bending a stainless steel sheet in a predetermined pattern. In an implementation, the blade cover 55 is formed so that the height of the shielding part 55b is equal to or higher than the thickness of the fixed blade 51.

The mounting part 55a of the blade cover 55 is arranged so that it is overlapped with the supporting structure 6a of the fixed blade supporting frame 6, is screwed by the supporting shafts 52 and 53 and is fixed to the fixed blade supporting frame 6. The shielding part 55b of the blade cover 55 is slightly protruded from the rear edge 61 of the supporting structure 6a of the fixed blade supporting frame 6. The end of the guide part 55c of the blade cover 55 is directed to the platen roller 40.

The operation of the movable blade 37 and the fixed blade 51 is described. As shown in FIG. 3, in a state in which the fixed blade supporting frame 6 is closed, the fixed blade 51 and the movable blade 37 are arranged so that the respective cutting parts 51a and 37a are opposite with the transport path P between them.

Touching parts 3b and 3c for respectively fitting to the fitting projections 51b and 51c of the fixed blade 51 are formed at both ends of the front edge of the bottom 3a of the cutter frame 3 in which the movable blade 37 is arranged. The touching part 3c is formed in a part on the side on which cutting is finished of the bottom 3a of the cutter frame 3 so that the touching part is slightly protruded toward the fixed blade supporting frame 6. The touching parts 3b and 3c are arranged so that each touching part and the lower surface of the movable blade 37 meet predetermined positional relationship and the fixed blade 51 is positioned in a position suitable for the movable blade 37 in a state in which its fitting projections 51b and 51c are respectively in contact with the touching parts 3b and 3c.

In a state in which the fixed blade supporting frame 6 is closed, the fitting projection 51b of the fixed blade 51 is overlapped with the touching part 3b of the cutter frame 3 from the upper side and the fitting projection 51c of the fixed blade 51 is overlapped with the touching part 3c of the cutter frame 3 from the upper side.

When the fitting projections 51b and 51c of the fixed blade 51 are respectively fitted to the touching parts 3b and 3c of the cutter frame 3 as shown in FIG. 2 or 3 when the fixed blade supporting frame 6 is closed, the fixed blade 51 is lifted from the supporting structure 6a of the fixed blade supporting frame 6 against the elastic force of the elastic structure 54, as a result, the cutting part 51a of the fixed blade 51 is exposed from the shielding part 55b of the blade cover 55, the movable blade 37 can cross the fixed blade 51 and can be slid on the fixed blade. The movable blade 37 moves in the direction shown by the arrow C by operating the cutter motor 31 and recording paper 9 is cut.

As each fitting between the fitting projections 51b and 51 of the fixed blade 51 and the touching parts 3b and 3c of the cutter frame 3 is released as shown in FIG. 1 or 5, if the fixed blade supporting frame 6 is open, the fixed blade 51 is pressed on the supporting structure 6a of the fixed blade supporting frame 6 by the elastic force of the elastic structure 54. As a result, the cutting part 51a of the fixed blade 51 is shielded in the shielding part 55b of the blade cover 55.

In an alternate embodiment, the height of a shielding part 55b of a blade cover 55 and in that a paper guide 70 is provided and the description of a part common to the first embodiment is omitted.

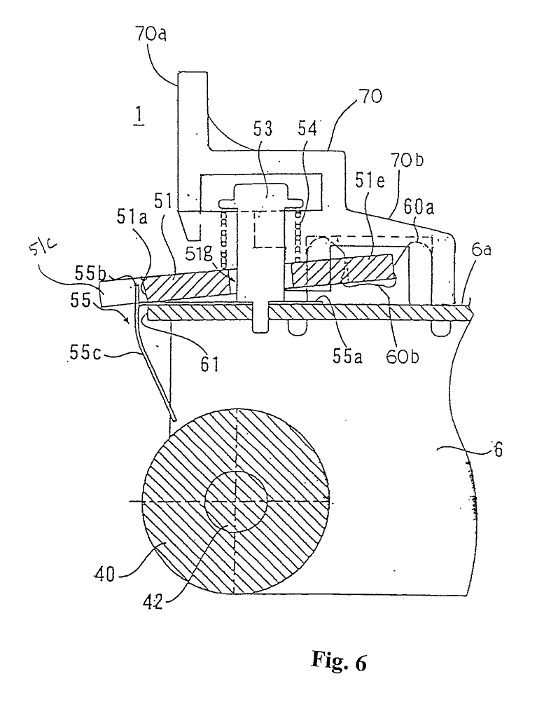

FIG. 6 is a sectional view equivalent to FIG. 5 and shows a state in which a fixed blade supporting frame 6 is open and a fixed blade 51 is pressed on supporting structure 6a of the fixed blade supporting frame 6 by the elastic force of an elastic structure 54.

In the alternate embodiment, as shown in FIG. 6, the shielding part 55b of the blade cover 55 is formed so that a part of the cutting part 51a of the fixed blade 51 is covered.

Namely, the height of the shielding part 55b of the blade cover 55 is shorter than the thickness of the fixed blade 51. The reason is that in the case the fixed blade 51 and the movable blade 37 cooperate therewith to cut the recording medium while the fixed blade supporting frame is closed, when the shield part 55b has a thickness which is close to the slidable surface defined between the fixed blade 51 and the movable blade 37, the angle defined between the recording paper and the fixed blade 51 or the movable blade 37 become in narrow, that is, the recording paper is inclined toward the movable blade side at the upstream of the transport direction and toward the fixed blade side at the downstream of the transport direction. This phenomenon increases the possibility of the cutting failure. As mentioned above, the height of the shielding part 55b is determined in consideration for the movement quantity of the fixed blade 51 along with open/close operation of the fixed blade supporting frame 6.

As the cutting part 51a of the fixed blade 51 approaches the shielding part 55b of the blade cover 55 when the fixed blade supporting frame is opened, the probability of problems such as damage to the cutting part 51a is reduced.

In consideration for the usual operation circumstance and the shape of the cutting part 51a of the fixed blade 51,. In consideration for the usual operation circumstance and the shape of the cutting part 51a of the fixed blade 51, it becomes apparent by experiment that the height of the shielding part 55b is approximately more than ½ of the thickness of fixed blade 51.

Further, a printer 1 in this embodiment is provided with a paper guide 70 for guiding the recording paper 9 after cutting out outside the printer. The paper guide 70 is provided with a guide part 70a for guiding recording paper, a pressing part 70b for closing the fixed blade supporting frame 6 and an attachment part 70c for attaching to the fixed blade supporting frame 6. The attachment part 70c is fitted to a positioning support 60 of the fixed blade supporting frame 6 and is screwed to the fixed blade supporting frame 6 approximately in the center of the pressing part 70b. In an embodiment, the paper guide 70 can be formed by molding resin.

The guide part 70a (a second projection) has a rectangular plane approximately parallel to the shielding part 55b of the blade cover 55 and protects the cutting part 51a of the fixed blade 51 in cooperation with the shielding part 55b of the blade cover 55. The guide part 70a is also used to guide paper. The probability in which foreign matter comes in contact with the cutting part 51a can be reduced by the plane of the guide part 70a and the plane of the shielding part 55b. Even if a foreign matter comes in contact with the cutting part 51a, pressure applied to the cutting part 51a can be reduced.

As described above, according to the present invention, as the fixed blade 51 is immediately moved and a part or the whole of the cutting part 51a is automatically shielded by the shielding part 55b of the blade cover 55 when the fixed blade supporting frame 6 is opened, the cutting part 51a can be securely protected and the cutting part 51a can be protected from chipping. Maintenance work and other types of access can be safely performed. As contact pressure between the cutting part 51a and the user's finger can be reduced even if a user accidentally touches a cutter blade, the user can avoid the injury of cutting a finger or the like.

As the cutting part 51a of the fixed blade 51 is automatically exposed from the shielding part 55b when the fixed blade supporting frame 6 is closed, the cutting part is able to immediately cut recording paper, and a cutter easy to handle and a printer provided with the cutter can be obtained.

Use of the fixed blade 51 pressed by the elastic force of the elastic structure 54 and the cutting part 51a shielded by the shielding part 55b, avoids use of a complicated mechanism such as a cam mechanism, and a cutting apparatus of the cutting part 51a of which can be shielded and a printer provided with the cutter can be obtained with simple configuration.

As the blade cover 55 is fixed to the fixed blade supporting frame 6 and the shielding part 55b is not moved even if external force is applied to the shielding part 55b of the blade cover 55, the cutting part of the fixed blade 51 is securely protected.

Furthermore, as the guide part 55c for guiding the carriage of recording paper 9 is integrated with the shielding part 55b, the guide part 55c can be precisely arranged for the shielding part 55b, and recording paper 9 can be securely guided to between the cutting parts 51a of the fixed blade 51 and the cutting parts 37a of the movable blade 37 along the guide part 55c.

In addition, the cutting part 51a of the fixed blade 51 can be more securely protected in cooperation with the shielding part 55b of the blade cover 55 by providing the guide part 70a of the paper guide 70.

As the guide part 55c is moved together with the fixed blade supporting frame 6 if the fixed blade supporting frame 6 is opened and the transport path P of recording paper 9 is free, work such as replacing rolled paper can be easily performed.

Of course, the present invention is not limited by the embodiment. Any modification could be applicable within the scope of the subject matter.

The form of the blade cover 55 is not limited to that in the above embodiments. The form can be suitably varied and may be also integrally formed by resin and other material.

The elastic structure 54 used to press the fixed blade 51 on the supporting structure of the fixed blade supporting frame 6, a compression coil spring has been disclosed in an embodiment. In another embodiment, a helical tension spring and other types of springs.

The fixed blade 51 is provided on the side of the frame 6 which can be opened or closed and the movable blade 37 is provided on the side of the body frame 2. The movable blade 37 may be also provided on the side of the frame which can be opened or closed and the fixed blade 51 may be also provided on the side of the body frame 2. However, to simplify the configuration, it is desirable that the cutting apparatus comprises as in the above embodiments.

The present invention can be applied to not only a thermal printer but also to other printers such as an impact dot printer and an ink-jet printer.

The cutting part of the cutter blade can be securely protected with simple configuration by providing a protruded member for covering a part or the whole of the cutting part of the cutter blade if the frame is opened in the configuration provided with the cutter blade on the frame which can be opened or closed.

Other embodiments are in the scope of the following claims.

What is claimed is:

1. A cutting apparatus for cutting recording paper, comprising:
first and second cutter blades arranged opposite with the transport path of said recording paper between them;
first supporting structure for supporting said first cutter blade; and
second supporting structure for supporting said second cutter blade and said second supporting structure movable with respect to said first supporting structure, wherein:
said second cutter blade is supported so that it can be moved to a first position in which said recording paper can be cut in cooperation with said first cutter blade and a second position in which said recording paper cannot be cut without cooperation with said first cutter blade depending upon the position of said second supporting structure; and said second supporting structure is provided with a first projection protruded on the side of said second cutter blade from the surface contact with said second cutter blade in said second position and located on the side of said transport path of said second cutter blade.

2. A cutting apparatus according to claim 1, wherein:
said second supporting structure is provided with an elastic body; and
said second cutter blade is pressed on the surface contact with said second cutter blade of said second supporting structure by the elastic force of said elastic body when said second cutter blade is located in said second position and a part or the whole of said second cutter blade is shielded by said first projection.

3. A cutting apparatus according to claim 2, wherein:
said first supporting structure is provided with a touching part for coming in contact with said second cutter blade and moving said second cutter blade to said first position against the elastic force of said elastic body.

4. A cutting apparatus according to claim 1, wherein:
said first projection is fixed to said second supporting structure.

5. A cutting apparatus according to claim 1, wherein:
a guide part f or guiding the carriage of said recording paper is provided; and
said guide part is integrated with said first projection.

6. A cutting apparatus according to claim 1, wherein:
said second supporting structure is provided with a second projection on the side opposite with said second cutter blade between to the surface contact with said second cutter blade of said second supporting structure.

7. A cutting apparatus according to claim 1, wherein:
said first cutter blade is a movable blade; and
said second cutter blade is a fixed blade.

8. A cutting apparatus according to claim 7, wherein:
said first cutter blade can cross said second cutter blade in the shape of clippers and can be slid on said second cutter blade in a state in which said first cutter blade is contact at a point with said second cutter blade.

9. A printer provided with a cutting apparatus according to claim 1, comprising:
a main frame provided with a print unit for printing on recording paper; and
a cover frame supported by said main frame so that the cover frame can be opened or closed, wherein:
said main frame includes said first supporting structure and said cover frame includes said second supporting structure; and
said cover frame is supported so that the cover frame can be turned between a closed position equivalent to said first position and an open position equivalent to said second position.
